(19) United States
(12) Patent Application Publication
(10) Pub. No.: US 2011/0052471 A1
(43) Pub. Date: Mar. 3, 2011

(54) CATALYTIC ABATEMENT SYSTEM FOR ORGANIC SOLVENT EMISSIONS

(75) Inventor: Johan K. KARS, Cincinnati, OH (US)

(73) Assignee: X-MACHINA, Cincinnati, OH (US)

(21) Appl. No.: 12/546,934

(22) Filed: Aug. 25, 2009

(51) Int. Cl. B01D 53/44; B01D 53/34

(52) U.S. Cl. 423/245.1; 422/145

(57) ABSTRACT

Method and apparatus for a point-of-origin catalytic abatement system, for treatment of gaseous organic solvent emissions is disclosed.

The heating element, forced fresh air fan and catalyst bed material are sized, constructed, arranged, and operated to affect a catalytic oxidation of gaseous organic solvent emissions in the catalyst bed material of the disclosed apparatus to yield essentially only carbon dioxide and water products.

The arrangement and process are such that direct contact of solvent gasses with the heating element is avoided to prevent pre-ignition of these solvents in gas phase.

In the process, the hot air stream is used to entrain cooler, ambient fresh air to manage both the surface temperature of the enclosure and the outlet temperature of the clean process exhaust.

### BACKGROUND OF THE INVENTION

The field of the present invention is methods and apparatuses for the abatement of emissions contaminated with organic solvents. In particular, the present invention relates to apparatuses and methods for exothermic reaction of organic solvent emissions from process industries, printing processes or laboratory assays, or other sources of organic solvent vapors, although it will be appreciated that the invention in its broader application can be applied to any process emitting organic solvents.

Organic solvents are used in many processes, ranging from printing to pharmaceutical production. The resulting solvent vapors can be toxic and dangerous and need to be abated or recycled.

These hazards and encumbrances have led to the current invention of a method and apparatus for abatement of gas streams contaminated with organic solvent vapors at the point of origin.

For example, common solvents frequently used in the reaction or purification processes in a laboratory setting include oxygenated hydrocarbons such as acetone, alcohols such as methanol and ethanol and nitrogen containing hydrocarbons such as acetonitrile, or sulfurous compounds such as dimethylsulfoxide. After the reaction or purification, the solvent must be extracted.

One method of extracting the solvents from a solution during a purification process such as indicated above, involves the use of a heated, pressurized nitrogen stream within a sealed enclosure. Such a device is often referred to as a vaporizer. A hot nitrogen stream impinges on the solvent and volatilizes it from a container, for example a flask or vial, within the vaporizer. The vaporization that occurs is further enhanced by shaking or agitation. The nitrogen and solvent vapors then need to be evacuated from the enclosure.

The evacuation process must be performed in a manner that minimizes exposure of the vapors to the environment and particularly to the operators and laboratory workers. In the past this has been accomplished by conducting the vaporization inside a laboratory hood or in a manner that otherwise cause the vapors to be vented outside of the laboratory building and away from laboratory personnel. This procedure has been unsatisfactory for several reasons, among them the space the vaporizer occupies in the hood. Furthermore the absence of abatement, the partial capture of the vapors and the exposure—both inside and outside the building—to the vapors that are released, resulting in exceeding Permissible Exposure Limits as documented in Material Safety Data Sheets.

One method employed to deal with vapors generated in a laboratory environment such as described above is the use of a collective incinerator such as disclosed in U.S. Pat. No. 5,516,499 (Carmo J. Pereira et al.). These devices are typically operated outside the building. Other than the high capital costs, these systems need to be kept at their operating temperatures regardless if solvents need to be incinerated or not, which results in high operating costs. Flame based destruction processes pose serious performance, regulatory and public acceptance issues. Incineration is difficult to control and can result in highly undesirable by-products such as oxides of nitrogen.

In other instances, condensation systems are used wherein vapors are condensed to a liquid form and captured. These systems do not allow continuous processing. Another serious limitation of such a condensation system is that the vapors are not captured completely. Typical condensation efficiencies are between 60% and 70% as stated in U.S. Pat. No. 5,925,291 (Desikan Bharathan et al.) After condensation and capture, these liquid solvents become a hazardous waste that must be appropriately disposed of in a costly, environmentally sound manner. Furthermore, use of a condensation vapor capture system requires time and effort to activate the condenser and maintain its functionality. An additional problem is handling the dry ice or other coolants used for condensation. During the operation of a condensation system the dry ice sublimates requiring recharging. Also, the dry ice sublimation results in clouding or fogging and condensation of ambient moisture. The physical space requirement of these condensation systems is typically 1 cubic meter. This attributes to their impracticality in the lab environment.

Another method of capturing fugitive solvent emissions in a typical laboratory environment is the application of a fixed activated carbon filter bed located at the outlet of an exhaust hood. The presence of any hygroscopic or hydrophilic solvent, i.e. alcohols or acetones is incompatible with activated carbon absorption and therefore renders this method obsolete. Activated carbon is unable to adsorb these compounds in their vapor phase as described in U.S. Pat. No. 4,259,094 (Hiroshi Nagai et al.).

Additionally, even in the absence of hygroscopic or hydrophilic solvents, other organic solvents which happen to be adsorbed can saturate the carbon bed and render it ineffective. Activated carbon requires desorption through a high temperature thermal process. This typically requires the spent carbon to be shipped off-site and treated as hazardous waste. Activated carbon merely provides a staging area for captured solvents. This raises the issue of contaminant disposal yet again.

Existing apparatus for catalytic oxidation such as described in U.S. Pat. No. 4,412,523 Richard J. Schreiber et al. and U.S. Pat. No. 5,914,091 (Mark R. Hoist et al.), heat up the volatile organic compounds directly. The direct contact of heating elements with the VOC-containing gas stream can result in combustion of the organic emissions and therefore requires extensive control and shielding of such an event.

In the context of workspace such as laboratories, measures need to be taken to avoid open flames and direct contact with heated equipment by personnel. Incinerators such as described above are therefore placed outside the workspace. Equipment surface temperatures, when operated by personnel can not exceed 49° C. as per OSHA standard Title 29 of the Code of Federal Regulations Part 1910 Subpart I. The disclosed point-of-origin catalytic oxidation system is designed and constructed in such a manner that the process creating heat for the reaction to take place is also used to cool the housing and the process gas exhaust. The system can therefore co-reside with the operators at its point of use.

### BRIEF SUMMARY OF THE INVENTION

The present invention relates generally to the field of solvent use. More specifically, the invention provides a method and system for abatement of organic solvents emissions. Merely by way of example, the invention has been applied to organic solvents emitted in laboratory assays, but it would be recognized that the invention has a much broader range of applicability.

The present invention comprising an electric, point of origin, solvent abatement system, both an apparatus and a method, which solves the problems inherent in the solvent extraction processes and devices of the past such as those described above. The electric, point of use, solvent abatement system provides a means to eliminate exposure to organic solvent emissions, both inside and outside of the laboratory, by converting or oxidizing them to harmless substances such as carbon dioxide and water in their vapor phases. These organic solvent vapors which emanate from oxygenated hydrocarbons such as acetone and alcohols are abated by the current invention while the device occupies relatively little space and is operational using readily available electrical utilities.

In the process, vaporized solvents are introduced into a stream of heated fresh air, supplied by the system's integral forced air fan and electrical heating element. The fresh air introduced results in a process air stream containing a stoichiometric amount of oxygen, at least 13% by volume, necessary to assure proper oxidation. The heated, contaminated process air passes through a conversion chamber charged with an alumina and noble metal catalyst designed to provide a space velocity and reactivity that enables oxygenation or combustion that effectively converts a high percentage of the vapors to harmless gases such as carbon dioxide and water.

The linear, vertical an in-line placement and the proximity of the heating element and catalyst element increase the temperature of the noble metal catalyst by radiant heat which promotes this conversion. Adding to the available heat is the thermal conduction of the metallic cylinder connecting the heating element and the catalyst element. Insulation material around the outside of the metallic cylinder reduces heat loss.

The exothermic reaction creates higher catalyst bed outlet temperatures which expands the clean exhaust gasses and increases their linear exhaust velocity within the tubular housing of the catalytic converter.

To shield off the high temperatures generated by the heating element and the conversion process from direct contact with the operator or user of the solvent abatement system, an enclosure is constructed around the catalytic converter in such a way that it is cooled by an entrained fresh air stream.

The hot air stream generated by the fan, heating element and conversion process entrains this cooler air at the exhaust point of the catalytic converter.

The hot air stream is generated by the process fan, the heating element's convective heat, the heating element's radiant heat being within line of sight and positioned on the inlet side of the catalyst bed and the conversion process itself.

The sequential, linear and upward arrangement of the internal conversion chamber components allows the current invention to benefit from the electrical resistance heater's near 100% conversion of electrical energy into thermal and radiant energy while eliminating unnecessary pressure drop.

The concentric placement of the catalytic converter's exhaust tube with the exhaust tube of the enclosure, where at the exhaust point of the first, the higher temperature, less dense exhaust gasses create a relative depression and become the motive (upward) fluid, whose advective fluid dynamic acts on the air in the enclosure, promotes an airflow inside the enclosure where fresh air is drawn in through an opening in the bottom of said enclosure. This fresh air stream cools the enclosure.

The two outlet flows mix at their exhaust point and decrease the ultimate exhaust temperature.

Unlike existing apparatus such as described above where organic emissions are directly heated, the present invention does not heat up the gaseous compounds directly but rather heats up the airstream containing a minimum of 13% oxygen in which the gaseous compounds are then introduced. This method prevents the solvents from coming in direct contact with the energy source. Thus avoiding the gaseous solvents from reaching their auto ignition temperature. The method of introducing the gaseous solvents downstream of the heating element also avoids fossil fuel combustion deposits on the catalyst bed.

The presently disclosed invention does not produce any by-products which require further abatement.

### BRIEF DESCRIPTION OF THE SEVERAL VIEWS OF THE DRAWINGS

FIG. 1 is a schematic view of the electric, point of origin, organic solvent emissions abatement system.

FIG. 2 is a schematic view of the housing containing the electric, point of origin, organic solvent emissions abatement system. The different air and gas flows are indicated.

FIG. 3 is a view of the top of the electric, point of origin, organic solvent emissions abatement system to illustrate the point where the heated process air entrains the cooler air from the enclosure.

### DETAILED DESCRIPTION OF THE INVENTION

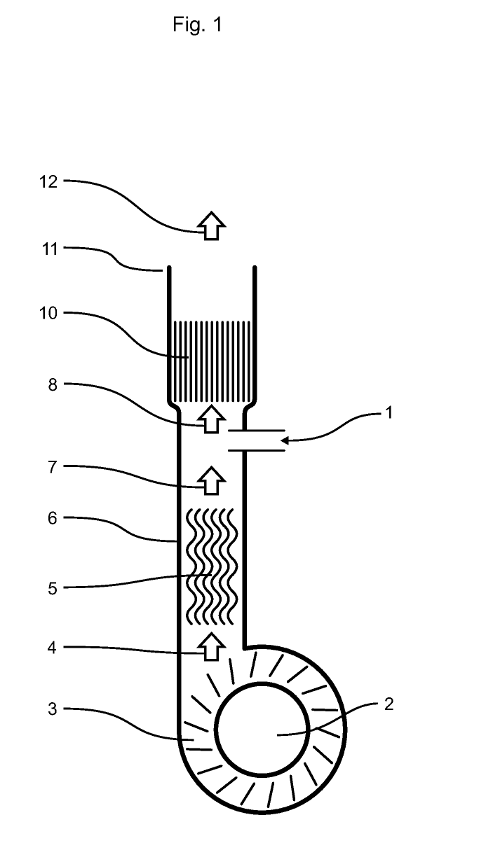

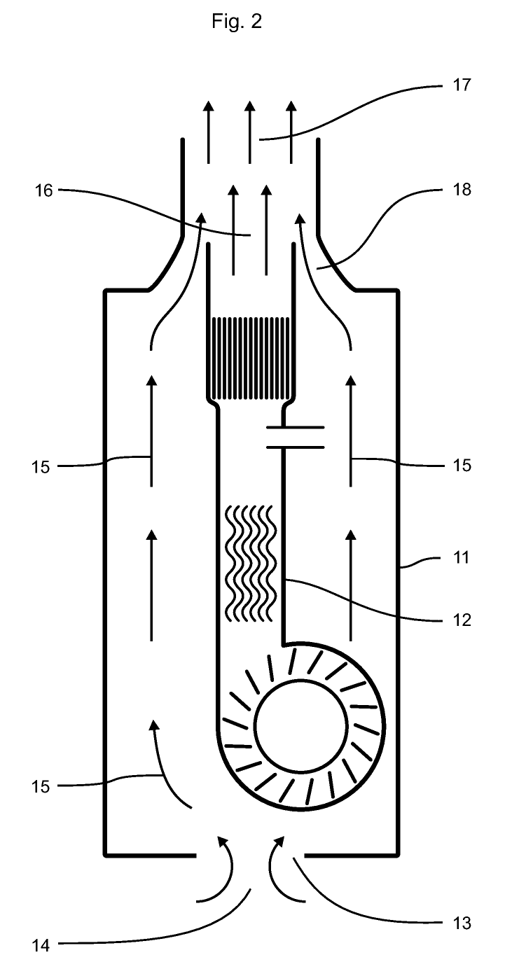

Air containing a minimum of 13% of oxygen is aspired (FIG. 1-2) through an air handling device such as a fan, (FIG. 1-3) and distributed over an electrical heating element (FIG. 1-5) which increases the air temperature to 400° C. The heated air (FIG. 1-7) is ducted through an enclosed means for example a tube like structure (FIG. 1-6) and passes an inlet (FIG. 1-1) through which organic solvent emissions such as e.g. an acetone or alcohol containing gas is introduced into the heated airstream.

The contaminated organic solvent emissions are introduced in the hot process air then passes through the catalyst module (FIG. 1-10). The heated mixture of gasses flows into an increased volumetric chamber (FIG. 1-8) slowing down the velocity of the gas stream.

The catalyst module (FIG. 1-10) comprises a catalyst chamber wherein a cylindrical, spiral wound, compressed catalyst substrate such as Pt and/or Pd and/or Rh, is placed. The catalyst substrate is sized to expose a maximum of catalyst material while maintaining sufficient air pressure velocity to produce a space velocity between 20,000 and 60,000/Hr. by using the formula: SV=volumetric flow/reactor volume=1/T.

When using a catalyst such as Pt and/or Pd and/or Rh, the heated air stream combined with the organic solvents stream ratio needs to be such that the organic solvents are heated to a temperature of minimum 315° C. This temperature is obtained by the combination of the heated process gasses and the radiant heat from the heating element.

An electrical heating element is chosen for its known quality of converting nearly 100% of the electrical energy into available heat.

Available heat is the heat per unit mass of a working substance that could be transformed into work in a process under ideal conditions for a given amount of heat per unit mass furnished to the working substance.

The amount of energy introduced into the process air stream is best described by:

Q=mCpΔT

Where Q is the energy per unit time put into a substance, m is the mass of the substance, Cp is the specific heat capacity of the substance, and ΔT is the temperature differential.

In this case the substance is fresh air mixed with solvents. Where Q is expressed in KWh, m in grams of air/minute and Cp is Joules/grams/degrees C.

The sources of energy are: thermal convection generated by the electrical heating source, thermal conduction through the metallic vertical cylinder, the radiant heat generated by the energized electrical coil's thermal emissivity which is in the line of sight of the catalyst.

The heat created by the conversion process.

Insulation material around the outside of the metallic cylinder (FIG. 2-9) reduces heat loss.

The Stefan-Boltzmann law states that the amount of thermal radiation emitted per second per unit area of the surface between two bodies is directly proportional to the fourth power of its absolute temperature.

The radiation transfers heat proportionally to the 4^{th} power of the absolute temperatures of the heat source and the heat sink. In this case the electrical heating element is the source and the catalyst bed is the primary heat sink.

That is:

j*=σT⁴,

Where:

j* is the total energy radiated per unit area per unit time, T is the temperature in Kelvin, and σ=5.67×10⁻⁸ W m⁻² K⁻⁴ is the Stefan-Boltzmann constant.

Radiant energy transmission is capable of continuing to heat an object's surface until its temperature approaches that of the heating element.

The second law of radiant heat states that the square of the distance from the radiant surface to the heat sink is inversely proportional to the transferred energy. Said another way, for every unit of distance between the bodies, the amount of energy loss is proportional to the square of that distance.

This formula is represented by the laws of radiant heat I=I/D²

Where:

### I=Radiant Energy

### D=Distance

In the disclosed invention, this distance D is calculated such that an increase of temperature is obtained in the electrically heated mix of fresh air and the introduced organic solvent emissions, containing a minimum of 13% oxygen by volume, to obtain a surface temperature of the catalyst of minimally 315° C.

The catalyst converts the organic solvent emissions into carbon dioxide and water in a conversion rate of 90% Min. to 99.9% Max. This reaction is represented by the following general chemical equation: VOC's+O2>CO2+H2O

The carbon dioxide and water leaves the system in vapor form at the catalyst exhaust (FIG. 1-12). The exothermic or chemical energy generated by the oxidation or disassociation of the hydrocarbons within the catalyst at reaction temperature results in a temperature of the process stream at the catalyst exhaust to be approximately 360° C.

To shield off the high temperatures generated by the heating element and the conversion process from direct contact with the operator or user of the solvent abatement system, an enclosure is constructed around the catalytic converter in such a way that it is cooled by an entrained fresh air stream (FIG. 2-11).

When the described electric, point of origin, solvent abatement system (FIG. 2-12) is in use, the heated exhaust flow (FIG. 2-16) entrains the air inside the system's enclosure (FIG. 2-11) using the concentric placement of the process exhaust and the opening at the top of the enclosure (FIG. 2-18). The resulting depression causes fresh air (FIG. 2-14) to enter through an opening in the bottom of the enclosure (FIG. 2-13) and flow through the enclosure (FIG. 2-15). The thus created airflow cools the enclosure.

Upon leaving the enclosure, the cooler air mixes with the hot exhaust flow decreasing the temperature of the process air (FIG. 2-17).

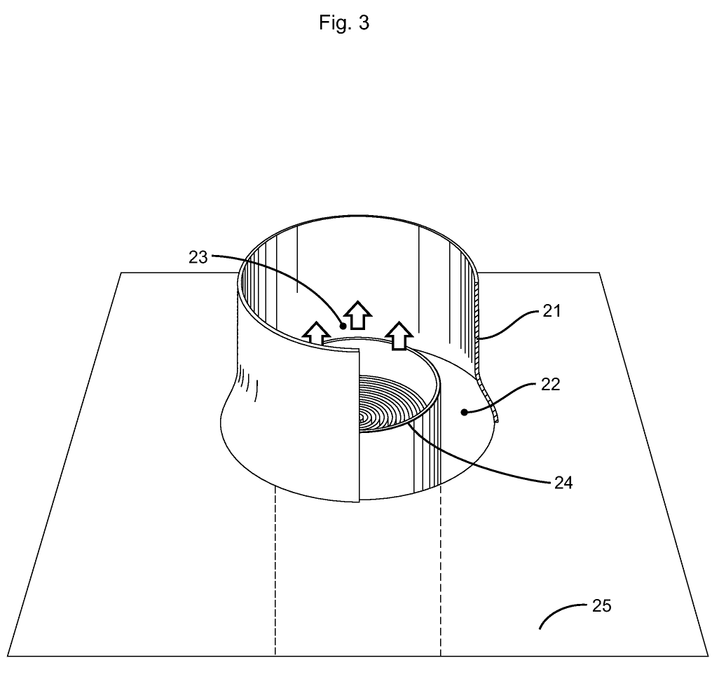

The design and ratio of the opening (FIG. 3-22) and exhaust (FIG. 3-21) in the top of the enclosure (FIG. 3-25) and the opening of the catalyst exhaust (FIG. 3-24) form a nozzle. The hot air flow from the catalyst exhaust (FIG. 3-23) is a motive fluid acting upon the air inside the enclosure.

The design of the inlet and outlet conditions including the opening in the bottom of the enclosure, allows this motive fluid to have an aspiration effect and to create airflow through the enclosure.

The fluid dynamics of this airflow is described as follows:

Since the fresh air is compressible, subject to atmospheric pressure, and in our case, laminar/not turbulent, the Bernoulli Equation applies where:

$$\frac{{V}^{2}}{2 g} + z + \frac{\tilde{P}}{g} = C ( streamline )$$

The function \tilde{P} is the “pressure per density” in the fluid, and follows from the barotropic equation of state where:

p=p(r)
g is the gravity acceleration constant (9.81 m/s²; 32.2 ft/s²)
V is the velocity of the fluid
z is the height above an arbitrary datum
C remains constant along any streamline in the flow, but varies from streamline to streamline.

Since the flow is irrational, then C has the same value for all streamlines.

The cooling fresh air induced from the bottom through the top is traveling at less than Mach 0.3, subject to changes from inlet cross section and outlet cross section, subject to inlet and outlet temperatures; and as a result, pressures, then:

Applying this equation to a streamline traveling, upward, vertically and through the housing but outside of the conversion chamber gives:

$$Δ p = {p}_{1} - {p}_{2} = \frac{1}{2} ρ {V}_{2}^{2} - \frac{1}{2} ρ {V}_{1}^{2}$$

where location 1 is the outlet, and location 2 is the inlet, and since the pressure at 1 will be higher than the pressure at 2 (for flow moving from 2 to 1), the pressure difference as defined will be a positive quantity.

From constancy of the streamline “C” formed by Bernoulli, the velocities can be replaced by cross-sectional areas of the flow and the volumetric flow rate Q,

$$Δ p = \frac{1}{2} ρ {Q}^{2} \frac{1}{{A}_{2}^{2}} [ 1 - {( \frac{{A}_{2}}{{A}_{1}} )}^{2} ]$$

Solving for the volumetric flow rate Q gives,

$$Q = \sqrt{\frac{2 Δ p}{ρ}} \frac{{A}_{2}}{\sqrt{1 - {( \frac{{A}_{2}}{{A}_{1}} )}^{2}}}$$

### Q=Volumetric Flow Rate of Air

### Delta P=P1−P2

A2=Cross Sectional area of inlet
A1=Cross Sectional area of outlet
p=density of air

This proves flow through the interior of the housing and outside of the conversion chamber.

The two outlet flows mix to lower the ultimate exhaust temperature.

The catalyst exhaust motive flow, the size of opening 1 and opening 2 and the opening in the bottom of the enclosure are designed so that the aspiration of the cooler air into the enclosure reduces the enclosure skin temperature while the aspiration of the cooler air from the enclosure and into the hot motive flow reduces the exhaust temperature so that the enclosure skin temperature does not exceed 49° C.

1. An apparatus for electric, point-of-origin, catalytic abatement of organic solvent emissions, comprising:
a) A means to introduce organic solvent emissions into a heated fresh airstream;
b) A fresh air inlet;
c) A forced air fan;
d) A forced air stream;
e) An electrical heating element for energy transfer to an air stream;
f) Said electrical heating element for energy transfer to a catalyst bed
g) An oxidizer comprising a bed of catalyst material for the oxidation of organic solvents in the organic solvent emissions gas stream;
h) An exhaust for the heated air and converted organic solvent emissions;
i) A duct containing the means to introduce organic solvent emissions, the fresh air inlet, the forced air fan, the electrical heating element, the oxidizer and the exhaust
The fresh air inlet, means to introduce organic solvent emissions, heating element, forced air fan, catalyst bed material, exhaust and duct are sized, constructed, arranged, and configured to effect a chemical reaction sufficient to produce catalytic oxidation of organic solvent emissions in the catalyst bed material of the oxidizer;
An enclosure, containing the elements a) through i);

2. The point-of-origin catalytic abatement system as in claim 1 wherein the forced air stream, the heating element, the introduction of the organic solvent containing gas stream, the catalyst and the exhaust are placed in line

3. The point-of-origin catalytic abatement system as in claim 1 wherein the forced air stream, the heating element, the introduction of the organic solvent containing gas stream, the catalyst and the exhaust are placed vertically

4. The point-of-origin catalytic abatement system as in claim 1 wherein the forced air stream, the heating element, the introduction of the organic solvent containing gas stream, the catalyst and the exhaust are placed inside the enclosure where the enclosure has an opening in the top

5. The point-of-origin catalytic abatement system as in claim 1 wherein the forced air stream, the heating element, the introduction of the organic solvent containing gas stream, the catalyst and the exhaust are placed inside the enclosure where the enclosure has an opening in the top to exhaust air through a tube

6. The point-of-origin catalytic abatement system as in claim 1 wherein the exhaust forms a nozzle

7. The point-of-origin catalytic abatement system as in claim 1 wherein the forced air stream, the heating element, the introduction of the organic solvent containing gas stream, the catalyst and the exhaust are placed inside the enclosure where the enclosure has an opening in the top to exhaust air through a tube and where the catalyst exhaust forms a nozzle which is placed concentrically with said tube

8. The point-of-origin catalytic abatement system as in claim 1 wherein the forced air stream, the heating element, the introduction of the organic solvent containing gas stream, the catalyst and the exhaust are placed inside the enclosure where the enclosure has an opening in the top to exhaust air through a tube and where the catalyst exhaust forms a nozzle which is placed concentrically with said tube creating a means to aspire air from within the enclosure

9. The point-of-origin catalytic abatement system as in claim 1 wherein the forced air stream, the heating element, the introduction of the organic solvent containing gas stream, the catalyst and the exhaust are placed inside the enclosure where the enclosure has an opening in the top to exhaust air through a tube and where the catalyst exhaust forms a nozzle which is placed concentrically with said tube creating a means to aspire air from within the enclosure and where the heated exhaust gases entrain cooler air from within the enclosure

10. The point-of-origin catalytic abatement system as in claim 1 wherein the forced air stream, the heating element, the introduction of the organic solvent containing gas stream, the catalyst and the exhaust are placed inside the enclosure where the enclosure has an opening in the top to exhaust air through a tube and where the catalyst exhaust forms a nozzle which is placed concentrically with said tube creating a means to aspire air from within the enclosure and where the heated exhaust gases entrain cooler air from within the enclosure and where fresh air is introduced through an opening in the bottom of said enclosure

11. The point-of-origin catalytic abatement system as in claim 1 wherein the forced air stream, the heating element, the introduction of the organic solvent containing gas stream, the catalyst and the exhaust are placed inside the enclosure where the enclosure has an opening in the top to exhaust air through a tube and where the catalyst exhaust forms a nozzle which is placed concentrically with said tube creating a means to aspire air from within the enclosure and where the heated exhaust gases entrain cooler air from within the enclosure and where fresh air is introduced through an opening in the bottom of said enclosure to thermically insulate said enclosure

12. The point-of-origin catalytic abatement system as in claim 1 wherein the forced air stream, the heating element, the introduction of the organic solvent containing gas stream, the catalyst and the exhaust are placed inside the enclosure where the enclosure has an opening in the top to exhaust air through a tube and where the catalyst exhaust forms a nozzle which is placed concentrically with said tube creating a means to aspire air from within the enclosure and where the heated exhaust gases entrain cooler air from within the enclosure and where fresh air is introduced through an opening in the bottom of said enclosure to mix with the heated exhaust gases

13. The point-of-origin catalytic abatement system as in claim 1 wherein the forced air stream, the heating element, the introduction of the organic solvent containing gas stream, the catalyst and the exhaust are placed inside the enclosure where the enclosure has an opening in the top to exhaust air through a tube and where the catalyst exhaust forms a nozzle which is placed concentrically with said tube creating a means to aspire air from within the enclosure and where the heated exhaust gases entrain cooler air from within the enclosure and where fresh air is introduced through an opening in the bottom of said enclosure to mix with the heated exhaust gases to lower the temperature of these exhaust gases

14. The method of introducing the organic solvent containing gas stream into the heated fresh air stream downstream of the heating element such as used in the point-of-origin catalytic abatement system as in claim 1

15. The method of claim 14 where the organic solvent does not come in contact with the heating element
